(19) United States
(12) Patent Application Publication
(10) Pub. No.: US 2025/0187664 A1
(43) Pub. Date: Jun. 12, 2025

(54) VEHICLE LOWER PART STRUCTURE

(71) Applicant: TOYOTA JIDOSHA KABUSHIKI KAISHA, Toyota-shi (JP)

(72) Inventor: Koji Saeki, Okazaki-shi (JP)

(73) Assignee: TOYOTA JIDOSHA KABUSHIKI KAISHA, Toyota-shi (JP)

(21) Appl. No.: 18/966,510

(22) Filed: Dec. 3, 2024

(30) Foreign Application Priority Data
Dec. 12, 2023 (JP) 2023-209508

(51) Int. Cl. B62D 21/03; B60R 16/04; B62D 21/15; H01M 50/242; H01M 50/249

(52) U.S. Cl. CPC B62D 21/03; B60R 16/04; B62D 21/152; H01M 50/242; H01M 50/249; H01M 2220/20

(57) ABSTRACT

A vehicle lower part structure includes: a battery frame configured to include side portions provided as a pair of right and left side portions and each extending in a vehicle front-rear direction and a cross portion extending in a vehicle width direction and coupling rear ends of the side portions, the battery frame enclosing a battery; and rear side frames provided as a pair of right and left rear side frames and each extending in the vehicle front-rear direction, front end portions of the rear side frames being connected to the battery frame, and the rear side frames are configured to include first fixed portions fixed to the cross portion and second fixed portions fixed to rear end surfaces of the side portions on a side further outward than the first fixed portions in the vehicle width direction.

### CROSS-REFERENCE TO RELATED APPLICATION

This application claims priority to Japanese Patent Application No. 2023-209508 filed on Dec. 12, 2023, incorporated herein by reference in its entirety.

### BACKGROUND

### 1. Technical Field

The present disclosure relates to a vehicle lower part structure.

### 2. Description of Related Art

Chinese Patent Application Publication No. 114940214 (CN 114940214 A) discloses a battery frame enclosing a battery. The battery frame of CN 114940214 A constitutes a frame of a vehicle body.

### SUMMARY

Incidentally, a side frame extending in a vehicle front-rear direction is connected to front and rear sides of the frame of the vehicle body. However, a load is input from the side frame to the battery frame at the time of collision of the vehicle and a moment thus acts according to the structure descried in CN 114940214 A. It may not be possible to satisfactorily maintain a fixed state between the side frame and the battery frame.

An object of the present disclosure is to obtain a vehicle lower part structure capable of improving collision safety performance in a structure in which a battery frame is caused to functions as a frame of a vehicle body.

A vehicle lower part structure according to claim 1 includes:
a battery frame configured to include side portions provided as a pair of right and left side portions and each extending in a vehicle front-rear direction and a cross portion extending in a vehicle width direction and coupling rear ends of the side portions, the battery frame enclosing a battery; and
rear side frames provided as a pair of right and left rear side frames and each extending in the vehicle front-rear direction, front end portions of the rear side frames being connected to the battery frame,
in which the rear side frames are configured to include first fixed portions fixed to the cross portion and second fixed portions fixed to rear end surfaces of the side portions on a side further outward than the first fixed portions in the vehicle width direction.

In the vehicle lower part structure according to claim 1, the battery frame is configured to include the side portions and the cross portion, and the side portions are provided as the pair of right and left side portions and each extend in the vehicle front-rear direction. The cross portion extends in the vehicle width direction and couples the rear ends of the side portions. Moreover, the rear side frames are connected to the battery frame. It is possible to transmit a load at the time of rear surface collision (at the time of rear collision) to the battery frame by the rear side frames being connected to the battery frame, and the battery frame functions as a frame of a vehicle body.

Also, the rear side frames are provided as the pair of right and left rear side frames and are configured to include the first fixed portions that are fixed to the cross portion of the battery frame and the second fixed portions that are fixed to the rear end surfaces of the side portions of the battery frame on the side further outward than the first fixed portions in the vehicle width direction. In this manner, the rear side frames are fixed to the rear end surfaces of the side portions at the second fixed portions even if a moment acts on the rear side frames and a force in a direction away from the side portions of the battery frame acts on the rear side frames at the time of rear collision. It is thus possible to maintain the fixed state between the rear side frames and the battery frame.

In the vehicle lower part structure according to claim 2, both end portions of the cross portion in the vehicle width direction serve as inclined portions that are inclined so as to be positioned on a vehicle front side toward outside in the vehicle width direction in a plan view in claim 1.

According to the vehicle lower part structure in claim 2, the inclined portions of the cross portion are inclined so as to be positioned on the vehicle front side toward the outside in the vehicle width direction in a plan view, and it is thus possible to efficiently transmit a collision load at the time of rear collision to the side portions via the inclined portions.

In the vehicle lower part structure according to claim 3, the first fixed portions are provided at connecting portions between linear portions extending linearly in the vehicle width direction and the inclined portions in the cross portion in claim 2.

According to the vehicle lower part structure of claim 3, the first fixed portions are provided at the connecting portions between the inclined portions and the linear portions. Accordingly, a load input from the rear side frames to the battery frame can be transmitted to both the inclined portions and the linear portions.

In the vehicle lower part structure according to claim 4, the rear side frames extend from the connecting portions toward a vehicle rear side in a plan view in claim 3.

According to the vehicle lower part structure of claim 4, a collision load transmitted from the side frames to the battery frame can be received by the first fixed portions.

A vehicle lower part structure according to claim 5 includes:
a battery frame configured to include side portions provided as a pair of right and left side portions and each extending in a vehicle front-rear direction and a cross portion extending in a vehicle width direction and coupling front ends of the side portions, the battery frame enclosing a battery; and
front side frames provided as a pair of right and left front side frames and each extending in the vehicle front-rear direction, rear end portions of the front side frames being connected to the battery frame,
the front side frames are configured to include first fixed portions fixed to the cross portion and second fixed portions fixed to front end surfaces of the side portions on a side further outward than the first fixed portions in the vehicle width direction.

According to the vehicle lower part structure of claim 5, the battery frame is configured to include the side portions and the cross portion, and the side portions are provided as the pair of right and left side portions and each extend in the vehicle front-rear direction. The cross portion extends in the vehicle width direction and couples the rear ends of the side portions. Further, the front side frames are connected to the battery frame. In this manner, it is possible to transmit a load at the time of front surface collision (at the time of front collision) to the battery frame by the front side frames being connected to the battery frame, and the battery frame functions as the frame of the vehicle body.

Furthermore, the front side frames are provided as the pair of the right and left front side frames, each of which includes a first fixed portion that is fixed to the cross portion of the battery frame and a second fixed portion that is fixed to each of the rear end surfaces of the side portions of the battery frame on the side further outward than the first fixed portion in the vehicle width direction. Accordingly, the front side frames are fixed to the rear end surfaces of the side portions at the second fixed portions even if a moment acts on the front side frames and a force in a direction away from the side portions of the battery frame acts on the front side frames at the time of front collision. It is thus possible to maintain the fixed state between the front side frames and the battery frame.

As described above, according to the vehicle lower part structure of the present disclosure, collision safety performance can be improved in the structure in which the battery frame is caused to function as a frame of a vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing a main part of a vehicle lower part structure according to a first embodiment;

FIG. 2 is a side view of a main part of the vehicle lower part structure according to the first embodiment as viewed from the left side of the vehicle;

FIG. 3 is a side view of the main part of the battery frame in the first embodiment as viewed from the left side of the vehicle; and

FIG. 4 is a plan view showing a main part of the vehicle lower part structure according to the second embodiment.

### DETAILED DESCRIPTION OF EMBODIMENTS

### First Embodiment

A vehicle lower part structure according to a first embodiment will be described with reference to the drawings.

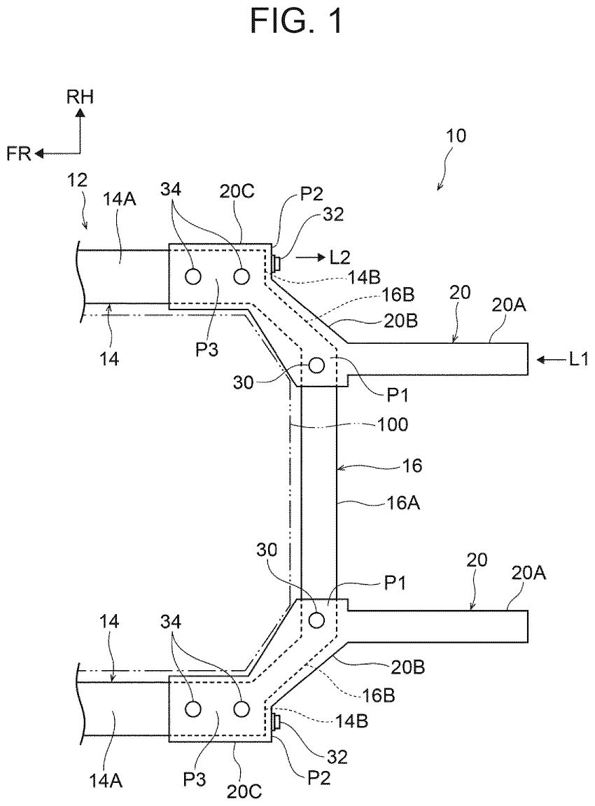

FIG. 1 is a plan view schematically showing a main part of a vehicle 10 to which a vehicle lower part structure according to an embodiment is applied. Note that the arrow FR, the arrow UP, and the arrow RH in the drawing indicate the vehicle front direction, the vehicle upper direction, and the vehicle right direction in the vehicle 10, respectively. In the following description, when the front, rear, up, down, and right and left directions are used without special mention, the front and rear directions in the vehicle front-rear direction, the up and down directions in the vehicle up-down direction, and the right and left directions in the vehicle left-right direction (width direction) are respectively indicated.

As illustrated in FIG. 1, a vehicle 10 to which the vehicle lower part structure of the present embodiment is applied includes a battery frame 12 and a rear side frame 20. The battery frame 12 is a frame that surrounds the battery 100 and includes a side portion 14 and a cross portion 16.

A pair of right and left side portions 14 are provided and extend in the vehicle front-rear direction. The side portions 14 may be formed in a closed cross-section by stacking steel plates, or may be formed by extrusion molding or the like. It may also be formed by casting or the like. For example, the right side portion 14 extends along the right side surface of the battery 100, and the left side portion 14 extends along the left side surface of the battery 100.

The cross portion 16 extends in the vehicle width direction and connects the rear ends of the side portions 14 to each other. The front ends of the side portions 14 are connected to each other in the vehicle width direction by a cross portion (not shown) similar to the cross portion 16. In the present embodiment, as an example, the cross portion 16 is integrally formed with the side portion 14. For example, the side portion 14 and the cross portion 16 may be integrally formed by casting or the like.

Here, the cross portion 16 includes a linear portion 16A and an inclined portion 16B. The linear portion 16A is provided at a center portion of the cross portion 16 in the vehicle width direction, and extends in the vehicle width direction.

The inclined portion 16B is provided at both end portions of the cross portion 16 in the vehicle width direction, and is inclined in a plan view so as to be positioned on the vehicle front side toward the vehicle width direction outer side. Specifically, the left end portion of the inclined portion 16B located at the right end portion of the cross portion 16 is connected to the linear portion 16A, and is inclined toward the vehicle front side from the left end portion toward the right end portion. The right end portion of the inclined portion 16B is connected to the rear end of the side portion 14.

On the other hand, a right end portion of the inclined portion 16B located at the left end portion of the cross portion 16 is connected to the linear portion 16A, and is inclined toward the front side of the vehicle from the right end portion toward the left end portion. The left end portion of the inclined portion 16B is connected to the rear end of the side portion 14.

A pair of right and left rear side frames 20 are provided and extend in the vehicle front-rear direction. Further, a front end portion of the rear side frame 20 is connected to the battery frame 12.

The rear side frame 20 may be formed, for example, by stacking steel plates and forming them in a closed cross-sectional shape, or by extrusion molding or the like. It may also be formed by casting or the like. Further, the rear side frame 20 may be connected in the vehicle width direction by a cross member (not shown). In this case, the cross member and the right and left rear side frames 20 may be integrally formed.

Here, each of the pair of right and left rear side frames 20 includes a front-rear extending portion 20A, a cross fastening portion 20B, and a side fastening portion 20C. In this embodiment, the front-rear extending portion 20A, the cross fastening portion 20B and the side fastening portion 20C are integrally formed as an example.

The right front-rear extending portion 20A extends in the vehicle front-rear direction, and the front end portion of the front-rear extending portion 20A is located at a connecting portion (border portion) between the linear portion 16A of the cross portion 16 and the right inclined portion 16B in the battery frame 12 in a plan view. Further, the left front-rear extending portion 20A extends in the vehicle front-rear direction, and the front end portion of the front-rear extending portion 20A is located at a connecting portion (border portion) between the linear portion 16A of the cross portion 16 and the left inclined portion 16B in the battery frame 12 in a plan view.

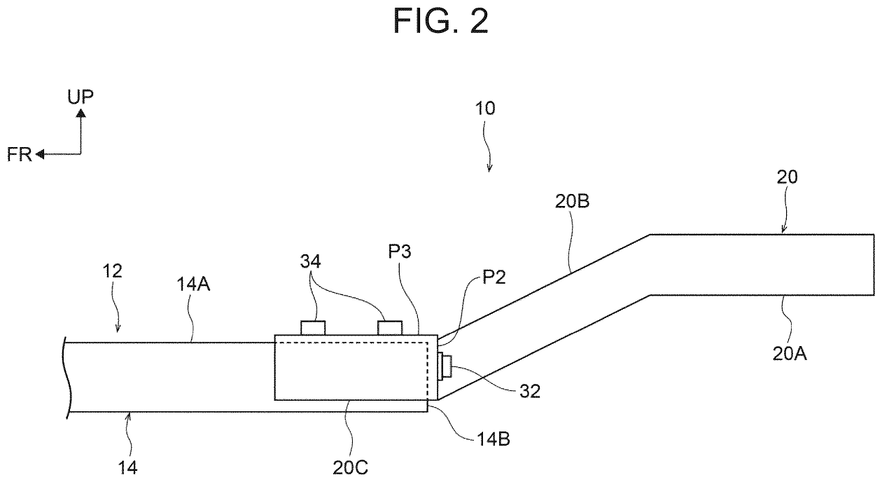

The rear end portion of the cross fastening portion 20B is connected to the front-rear extending portion 20A, and is inclined so as to be positioned outward in the vehicle widthwise direction in a plan view toward the vehicle front. Further, as shown in FIG. 2, the cross fastening portion 20B is inclined so as to be positioned downward from the rear end portion toward the front end portion in a side view. That is, the cross fastening portion 20B of the rear side frame 20 is inclined so as to be located on the vehicle width-direction outer side and the vehicle lower side from the rear end portion connected to the front-rear extending portion 20A toward the vehicle front side.

As shown in FIG. 1, the side fastening portion 20C extends in the front-rear direction, and the rear end portion of the side fastening portion 20C is connected to the front end portion of the cross fastening portion 20B. Further, as shown in FIG. 2, the side fastening portion 20C is superposed so as to cover the side portion 14 of the battery frame 12 from above. In the present embodiment, the side fastening portion 20C includes a portion superimposed on the upper surface 14A of the side portion 14 and a portion superimposed on the vehicle-width-direction outer surface of the side portion 14.

Here, as shown in FIG. 1, the rear side frame 20 is fixed to the battery frame 12 at the first fixed portion P1, the second fixed portion P2, and the third fixed portion P3. The first fixed portion P1 is set at a connecting portion between the linear portion 16A and the inclined portion 16B in the battery frame 12. In the first fixed portion P1, the cross portion 16 of the battery frame 12 and the cross fastening portion 20B are mechanically fastened by screwing the bolt 30 from above the vehicle. Note that a weld nut or the like which is screwed with the bolt 30 may be provided in the closed cross section of the cross portion 16.

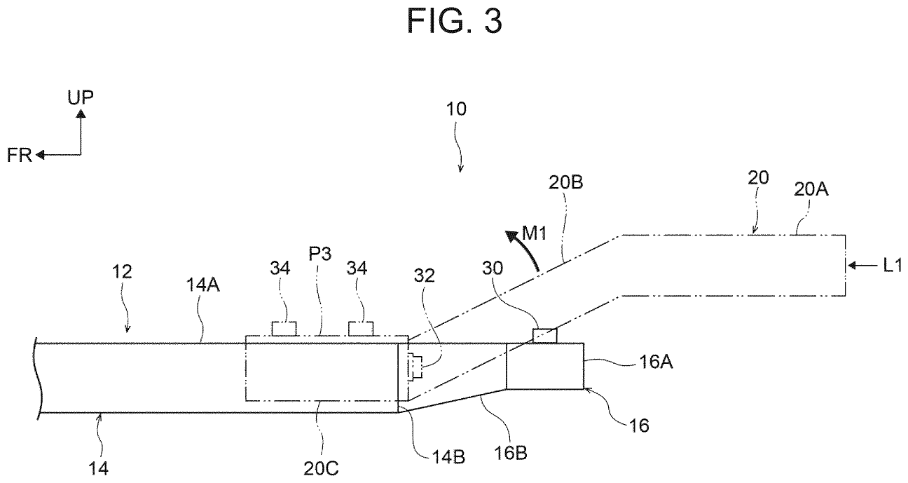

As shown in FIG. 3, the first fixed portion P1 of the present embodiment is set lower than the main body of the cross fastening portion 20B of the rear side frame 20. Therefore, the cross fastening portion 20B and the cross portion 16 are fastened by screwing the bolt 30 to the mounting seat branched from the cross fastening portion 20B, for convenience of explanation, illustration of the mounting seat is omitted.

As shown in FIGS. 1 and 2, the second fixed portion P2 is set to the rear end surface 14B of the side portion 14 on the vehicle-width-direction outer side of the first fixed portion P1. In the second fixed portion P2, the rear side frame 20 and the battery frame 12 are fastened by screwing the bolt 32 from the rear side of the vehicle while the side fastening portion 20C is overlapped from above the side portion 14. Note that a weld nut or the like which is screwed with the bolt 32 may be provided in the closed cross section of the side portion 14.

The third fixed portion P3 is set to be closer to the front of the vehicle than the second fixed portion P2. In the third fixed portion P3, the rear side frame 20 and the battery frame 12 are fastened by screwing the two bolts 34 from the vehicle-upper side of the side fastening portion 20C while the side fastening portion 20C is overlapped from the upper side of the side portion 14. Note that a weld nut or the like which is screwed with each of the bolts 34 may be provided in the closed cross section of the side portion 14.

### Operations

Next, the operation of the vehicle lower part structure according to the present embodiment will be described.

In the vehicle lower part structure according to the present embodiment, as shown in FIG. 1, the battery frame 12 includes a side portion 14 and a cross portion 16, and the side portions 14 are provided in a pair to extend in the vehicle front-rear direction. The cross portion 16 extends in the vehicle width direction and connects the rear ends of the side portions 14 to each other. Further, the rear side frame 20 is connected to the battery frame 12. As described above, when the rear side frame 20 is connected to the battery frame 12, a load at the time of a rear-surface collision (at the time of rear collision) can be transmitted to the battery frame 12, and the battery frame 12 functions as a frame of the vehicle body. That is, it is not necessary to provide a skeleton at the lower part of the vehicle separately from the battery frame 12, and the mounting volume of the battery 100 can be increased.

Further, the rear side frame 20 includes a pair of right and left, and includes a first fixed portion P1 fixed to the cross portion 16 of the battery frame 12, and a second fixed portion P2 fixed to the rear end surface 14B of the side portion 14 of the battery frame 12 on the vehicle-width-direction outer side of the first fixed portion P1. Accordingly, even if a moment acts on the rear side frame 20 at the time of rear collision and a force acts on the rear side frame 20 away from the side portion 14 of the battery frame 12, the rear side frame 20 is fixed to the rear end surface 14B of the side portion 14 at the second fixed portion P2. Therefore, the rear side frame 20 and the battery frame 12 can be maintained in a fixed state.

That is, in FIG. 1, when the impact load is inputted to the rear side frame 20 in the direction of the arrow L1 in the drawing at the time of the rear collision, a moment is generated toward the side fastening portion 20C in the direction of the arrow L2 in the drawing. At this time, since the rear side frame 20 is fixed to the rear end surface 14B of the side portion 14 at the second fixed portion P2, the rear side frame 20 and the battery frame 12 can be kept fixed.

Further, in the present embodiment, the inclined portion 16B of the cross portion 16 of the battery frame 12 is inclined so as to be positioned on the vehicle front side toward the vehicle width-direction outer side in a plan view. Therefore, the impact load at the time of the rear collision can be efficiently transmitted to the side portion 14 via the inclined portion 16B. That is, in the configuration in which the side portion 14 and the cross portion 16 are connected at a substantially right angle in plan view, the load is concentrated on the connecting portion, but in the present embodiment, the concentration of the load can be suppressed, and the load is easily transmitted from the inclined portion 16B to the side portion 14.

Further, in the present embodiment, the first fixed portion P1 is provided at a connecting portion between the inclined portion 16B and the linear portion 16A. Accordingly, the load inputted from the rear side frame 20 to the battery frame 12 can be transmitted to both the inclined portion 16B and the linear portion 16A. In particular, when the collision load is inputted from the obliquely rear side, the load transmitted from the rear side frame 20 on the collision side to the battery frame 12 can be transmitted to the anti-collision side via the linear portion 16A.

Furthermore, in the present embodiment, the front end portion of the front-rear extending portion 20A of the rear side frame 20 is connected to the vicinity of the first fixed portion P1. Accordingly, the impact load transmitted from the front-rear extending portion 20A can be received by the first fixed portion P1.

### Second Embodiment

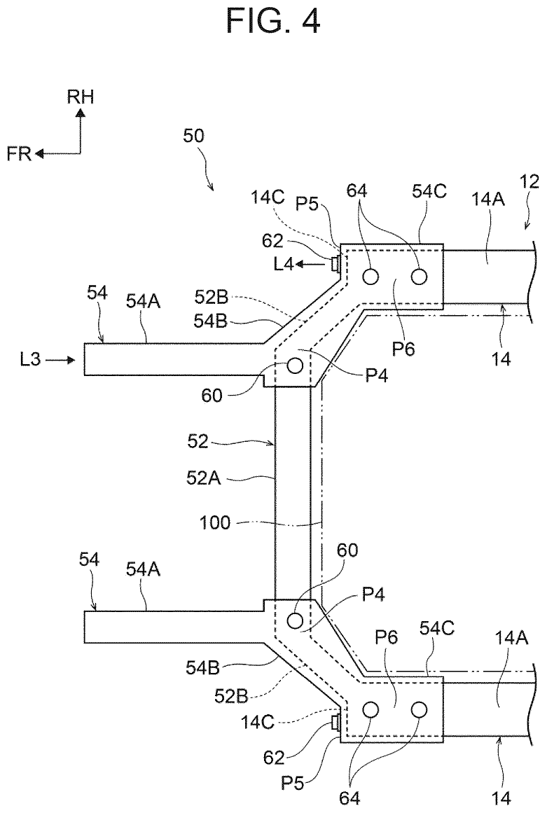

Next, the vehicle lower part structure according to the second embodiment will be described with reference to FIG. 4. Note that the same reference numerals are given to the same components as in the first embodiment, and description thereof will be omitted as appropriate.

FIG. 4 is a plan view showing a main part of the vehicle lower part structure according to the second embodiment. As shown in FIG. 4, the vehicle 50 to which the vehicle lower part structure of the present embodiment is applied includes a battery frame 12 and a front side frame 54. The battery frame 12 is a frame surrounding the battery 100 and includes a side portion 14 and a cross portion 52.

The cross portion 52 extends in the vehicle width direction and connects the front ends of the side portions 14 to each other. Here, the cross portion 52 includes a linear portion 52A and an inclined portion 52B. The linear portion 52A is provided at a center portion of the cross portion 52 in the vehicle width direction, and extends in the vehicle width direction.

The inclined portion 52B is provided at both end portions of the cross portion 52 in the vehicle width direction, and is inclined in a plan view so as to be positioned on the vehicle rear side toward the vehicle width direction outer side. Specifically, the left end portion of the inclined portion 52B located at the right end portion of the cross portion 52 is connected to the linear portion 52A, and is inclined toward the vehicle rear side from the left end portion toward the right end portion. The right end portion of the inclined portion 52B is connected to the rear end of the side portion 14.

On the other hand, in the inclined portion 16B located at the left end portion of the cross portion 16, the right end portion is connected to the linear portion 16A, and is inclined toward the rear side from the right end portion toward the left end portion. The left end portion of the inclined portion 16B is connected to the rear end of the side portion 14.

A pair of right and left front side frames 54 are provided and extend in the vehicle front-rear direction. A front end portion of the front side frame 54 is connected to the battery frame 12.

The front side frame 54 may be formed, for example, by stacking steel plates and forming them in a closed cross section, or by extrusion molding or the like. It may also be formed by casting or the like. Further, the front side frame 54 may be connected in the vehicle width direction by a cross member (not shown). In this case, the cross member and the right and left front side frames 54 may be integrally formed.

Here, each of the pair of right and left front side frames 54 includes a front-rear extending portion 54A, a cross fastening portion 54B, and a side fastening portion 54C. In this embodiment, the front-rear extending portion 54A, the cross fastening portion 54B and the side fastening portion 54C are integrally formed as an example.

The right front-rear extending portion 54A extends in the vehicle front-rear direction, and the rear end portion of the front-rear extending portion 54A is located at a connecting portion (border portion) between the linear portion 52A of the cross portion 52 and the right inclined portion 52B in the battery frame 12 in a plan view. Further, the left front-rear extending portion 54A extends in the vehicle front-rear direction, and the rear end portion of the front-rear extending portion 54A is located at a connecting portion (border portion) between the linear portion 52A of the cross portion 52 and the left inclined portion 52B in the battery frame 12 in a plan view.

The rear end portion of the cross fastening portion 54B is connected to the front-rear extending portion 54A, and is inclined so as to be positioned outward in the vehicle widthwise direction in a plan view toward the vehicle rear side. Further, as shown in FIG. 2, the cross fastening portion 54B is inclined so as to be positioned downward from the front end portion toward the rear end portion in a side view. That is, the cross fastening portion 54B of the rear side frame 20 is inclined so as to be positioned on the vehicle width-direction outer side and the vehicle lower side from the front end portion connected to the front-rear extending portion 54A toward the vehicle rear side.

Here, the front side frame 54 is fixed to the battery frame 12 at the fourth fixed portion P4, the fifth fixed portion P5, and the sixth fixed portion P6. The fourth fixed portion P4 is set at a connecting portion between the linear portion 52A and the inclined portion 52B in the battery frame 12. In the fourth fixed portion P4, the cross portion 52 of the battery frame 12 and the cross fastening portion 54B are mechanically fastened by screwing the bolt 60 from above the vehicle. Note that a weld nut or the like which is screwed with the bolt 60 may be provided in the closed cross section of the cross portion 52.

The fifth fixed portion P5 is set to the front end surface 14C of the side portion 14 on the vehicle-width-direction outer side with respect to the fourth fixed portion P4. In the fifth fixed portion P5, the front side frame 54 and the battery frame 12 are fastened by screwing the bolt 62 from the front side of the vehicle while the side fastening portion 54C is overlapped from above the side portion 14. Note that a weld nut or the like which is screwed with the bolt 62 may be provided in the closed cross section of the side portion 14.

The sixth fixed portion P6 is set to be behind the fifth fixed portion P5. In the sixth fixed portion P6, the front side frame 54 and the battery frame 12 are fastened by screwing the two bolts 64 from the vehicle-upper side of the side fastening portion 54C while the side fastening portion 54C is overlapped from the upper side of the side portion 14. Note that a weld nut or the like which is screwed with each of the bolts 64 may be provided in the closed cross section of the side portion 14.

### Operations

Next, the operation of the vehicle lower part structure according to the present embodiment will be described.

In the present embodiment, in FIG. 4, when a collision load is inputted to the front side frame 54 in the direction of the arrow L3 in the drawing at the time of the front collision, a moment is generated toward the side fastening portion 54C in the direction of the arrow L4 in the drawing. At this time, since the front side frame 54 is fixed to the front end surface 14C of the side portion 14 at the fifth fixed portion P5, the front side frame 54 and the battery frame 12 can be maintained fixed. Other operations are the same as in the first embodiment.

Although the vehicle lower part structure according to the present disclosure has been described above, it is needless to say that the present disclosure can be implemented in various forms without departing from the scope of the present disclosure. For example, in the above-described embodiment, both end portions of the cross portion 16 are inclined portions inclined so as to be positioned on the vehicle front side toward the vehicle width direction outer side in a plan view, but the present disclosure is not limited thereto. That is, although a structure in which the cross portion and the side portion are joined at substantially right angles may be employed, a structure in which both end portions of the cross portion are inclined is preferable from the viewpoint of suppressing the collision load from concentrating on the corner portion.

Further, in the above-described embodiment, the battery frame 12 and the rear side frame 20 are fastened to the first fixed portion P1 by one bolt 30, but the present disclosure is not limited thereto and may be fastened by a plurality of bolts. Similarly, the second fixed portion P2 and the third fixed portion P3 are not limited. Further, the battery frame 12 and the rear side frame 20 may be mechanically fastened by a method other than bolts.

What is claimed is:

1. A vehicle lower part structure comprising:
a battery frame configured to include side portions provided as a pair of right and left side portions and each extending in a vehicle front-rear direction and a cross portion extending in a vehicle width direction and coupling rear ends of the side portions, the battery frame enclosing a battery; and
rear side frames provided as a pair of right and left rear side frames and each extending in the vehicle front-rear direction, front end portions of the rear side frames being connected to the battery frame, wherein the rear side frames are configured to include first fixed portions fixed to the cross portion and second fixed portions fixed to rear end surfaces of the side portions on a side further outward than the first fixed portions in the vehicle width direction.

2. The vehicle lower part structure according to claim 1, wherein both end portions of the cross portion in the vehicle width direction serve as inclined portions that are inclined so as to be positioned on a vehicle front side toward outside in the vehicle width direction in a plan view.

3. The vehicle lower part structure according to claim 2, wherein the first fixed portions are provided at connecting portions between linear portions extending linearly in the vehicle width direction and the inclined portions in the cross portion.

4. The vehicle lower part structure according to claim 3, wherein the rear side frames extend from the connecting portions toward a vehicle rear side in a plan view.

5. A vehicle lower part structure comprising:
a battery frame configured to include side portions provided as a pair of right and left side portions and each extending in a vehicle front-rear direction and a cross portion extending in a vehicle width direction and coupling front ends of the side portions, the battery frame enclosing a battery; and
front side frames provided as a pair of right and left front side frames and each extending in the vehicle front-rear direction, rear end portions of the front side frames being connected to the battery frame, wherein the front side frames are configured to include fourth fixed portions fixed to the cross portion and fifth fixed portions fixed to front end surfaces of the side portions on a side further outward than the fourth fixed portions in the vehicle width direction.
